(19) United States
(12) Patent Application Publication
(10) Pub. No.: US 2003/0058246 A1
(43) Pub. Date: Mar. 27, 2003

(54) Force-mediated rasterization

(76) Inventor: Gregory Robert Roelofs, San Jose, CA (US)

Correspondence Address: Corporate Patent Counsel, U.S. Philips Corporation, 580 White Plains Road, Tarrytown, NY, 10591, US

(21) Appl. No.: 09/960,064

(22) Filed: Sep. 21, 2001

(51) Int. Cl. G06T 11/20

(52) U.S. Cl. 345/467; 345/440

(57) ABSTRACT

A rendering system models a glyph as a continuous mass, upon which forces act. Each pixel has the ability to exert a force on the glyph. If the pixel is entirely covered by a glyph, it is ‘stable’, and exerts no force. If the pixel is partially covered by a glyph, it exerts a force on the glyph, in an attempt to move the glyph until the pixel is completely covered. The strength of the force is dependent upon the amount of coverage of the pixel, and the direction of the force is dependent upon the location of the coverage of the pixel. Because all of the partially covered pixels exert a force on the glyph to maximize their coverage by the glyph, the glyph will move in the direction corresponding to a vector sum of the individual forces, until an equilibrium point is reached. Assuming that the amount of partial coverage of a pixel corresponds to the degree of distortion that will be produced when the pixel is rendered, the balancing of the forces of all the pixels on the glyph results in a minimization of this distortion. Additionally, glyphs are modeled to effect a force on adjacent glyphs, based on a preferred spacing between the glyphs.

### BACKGROUND OF THE INVENTION

1. Field of the Invention

This invention relates to the field of computers, and in particular to the rendering of symbols.

2. Description of Related Art

Symbols, including alphanumeric characters and the like, are generally predefined for rendering on a display screen or printer. When the symbol is displayed on a particular display device, or printed on a particular printing device, the symbol is appropriately scaled in accordance with the selected scale for the display or printer. Scalable fonts/symbols are generally defined as a series of continuous strokes, or outlines, defined as ‘analog’ vector objects.

As is known in the art, display devices and printers are designed based on a row and column matrix design, wherein a matrix of individual picture elements (pixels) or print elements are each assigned a particular value to represent the intended symbol, or glyph. When an analog vector object is scaled, the digitization of the scaled object into values of discrete pixels introduces errors when the vector object covers only a portion of a discrete pixel. If the pixel is assigned the color of the object, then the uncovered portion of the pixel will be in error; if the pixel is assigned the color of the background, then the covered portion of the pixel will be in error.

FIG. 1A illustrates an example glyph 101 in the context of a matrix 110 of picture (or print) elements 111 in accordance with this invention. For ease of reference, picture elements (pixels) are used hereinafter, without intent to limit the scope of this invention; also for ease of reference, each pixel is characterized as having two states: black and white, although one of ordinary skill in the art will recognize that the principles of this invention are applicable to gray-scale and color displays as well.

FIG. 1B illustrates a rendering of the glyph 101 in FIG. 1A, by turning specific pixels 111 on or off, corresponding to the location of the strokes of the glyph. In this example, if the glyph covers more than half the area of a pixel, the pixel is rendered black; otherwise, it is rendered white.

FIG. 1C illustrates the same glyph 101 in the context of the matrix 110 of pixels, but relative to FIG. 1A, the glyph 101′ of FIG. 1C is shifted slightly to the left. FIG. 1D illustrates the resultant rendering of the glyph 101′ using the same 50%-area rule for rendering a pixel black or white. As can be seen, a slight translation of the glyph 101 can produce a different rendering of the same glyph, depending upon the relationship between the matrix of pixels and the location of the glyph. In this example, the rendering of the glyph “a” 101′ is a bit rounder, which may be visually more appealing than the rendering illustrated in FIG. 1B.

FIG. 2A illustrates an example multi-glyph word 201 on a matrix 210 of pixels. FIG. 2B illustrates the rendering of the multi-glyph word 201, using the same 50%-area rule for determining whether a pixel is rendered black or white. Note that in FIG. 2B, the space between the glyph “d” 221 and the glyph “e” 222 appears wider than other spaces between the glyphs. This anomaly can be visually disturbing, sometimes giving the impression that the multi-glyph word (“ideal”) is actually two separate words (“id” and “eal”).

FIG. 2C illustrates the example multi-glyph word 201, but rendered with the glyph “e” 222′ shifted slightly to the left. Via the slight shift, the shape of the “e” is rendered a bit rounder, and the space between the “d” 221 and “e” 222′ is reduced, producing a more visually pleasing result.

Various rules and algorithms have been developed to produce renderings of glyphs and groups of glyphs so as to produce a visually appealing rendering. U.S. Pat. No. 5,684,510 “METHOD OF FONT RENDERING EMPLOYING GRAYSCALE PROCESSING OF GRID FITTED FONTS”, issued Nov. 4, 1997 to Lenox H. Brassell, Peter D. Pathe, and Eliyezer Kohen, details the technique used by font designers of providing “hints”, or slight distortions to a glyph, to assure that key-details of the symbol are not “dropped-out” when they might otherwise not cover a sufficient area of a pixel, particularly at a reduced scale. Because the font designer must provide these hints, the process of creating a visually appealing set of scalable fonts via the use of hints can be a time and resource consuming process. U.S. Pat. No. 5,910,805 “METHOD FOR DISPLAYING BITMAP DERIVED TEXT AT A DISPLAY HAVING LIMITED PIXEL-TO-PIXEL SPACING RESOLUTION”, issued Jun. 8, 1999 to Thomas B. Hickey and Robert J. Haschart, for example, teaches the rendering of glyphs by positioning a compressed form of the glyph using typesetting specifications, and then scaling and filtering the rendering at this determined position.

Ideally, the positioning of a glyph is determined so that, overall, the rendering provides a visually pleasing result. Generally, this requires a ‘balancing’ of distortions: some regions of the glyph may appear better if the glyph is moved to the left, some regions may appear better if the glyph is moved to the right, other regions may appear better if not moved at all. If both vertical and horizontal position adjustments are permitted, the balancing is effected in both directions, generally independent of each other.

### BRIEF SUMMARY OF THE INVENTION

It is an object of this invention to provide a method and system for rendering glyphs that provides a visually pleasing result. It is a further object of this invention to provide a method and system for positioning a glyph that provides a balancing of the perceived distortions in the rendering of a glyph. It is a further object of this invention to provide a method and system for positioning each glyph within a multi-glyph rendering that provides a balancing of the spacing between glyphs, without substantially affecting the balance of distortion of the individual glyphs. It is a further object of this invention to provide a method and system for rendering glyphs that requires minimal manual intervention.

These objects, and others, are achieved by providing a rendering system that models a glyph as a continuous mass, upon which forces act. Each pixel has the ability to exert a force on the glyph. If the pixel is entirely covered by a glyph, it is ‘stable’, and exerts no force. If the pixel is partially covered by a glyph, it exerts a force on the glyph, in an attempt to move the glyph until the pixel is completely covered. The strength of the force is dependent upon the amount of coverage of the pixel, and the direction of the force is dependent upon the location of the coverage of the pixel. Because all of the partially covered pixels exert a force on the glyph to maximize their coverage by the glyph, the glyph will move in the direction corresponding to a vector sum of the individual forces, until an equilibrium point is reached. Assuming that the amount of partial coverage of a pixel corresponds to the degree of distortion that will be produced when the pixel is rendered, the balancing of the forces of all the pixels on the glyph results in a minimization of this distortion.

### BRIEF DESCRIPTION OF THE DRAWINGS

The invention is explained in further detail, and by way of example, with reference to the accompanying drawings wherein:

FIG. 1A illustrates an example glyph overlaying a matrix of pixels.

FIG. 1B illustrates a resultant rendering of the example glyph of FIG. 1A, based on the degree of coverage of each pixel by the glyph.

FIG. 1C illustrates the example glyph of FIG. 1A, but shifted slightly relative to the matrix of pixels.

FIG. 1D illustrates the resultant rendering of the glyph of FIG. 1C, based on the degree of coverage of each pixel by the glyph at this shifted location.

FIG. 2A illustrates an example multi-glyph word overlaying a matrix of pixels.

FIG. 2B illustrates a rendering of the example multi-glyph word that shows a visually distracting space between two of the glyphs forming the multi-glyph word.

FIG. 2C illustrates an alternative rendering of the example multi-glyph word, wherein one of the glyphs is shifted slightly to produce a more visually appealing display of the multi-glyph word.

FIG. 3 illustrates an example block diagram of a rendering system in accordance with this invention.

FIG. 4 illustrates an example model of a matrix of pixels in accordance with this invention.

FIG. 5 illustrates a modeling of the force applied to the glyph by a partially covered pixel in accordance with this invention.

FIG. 6 illustrates an example model of a matrix of pixels

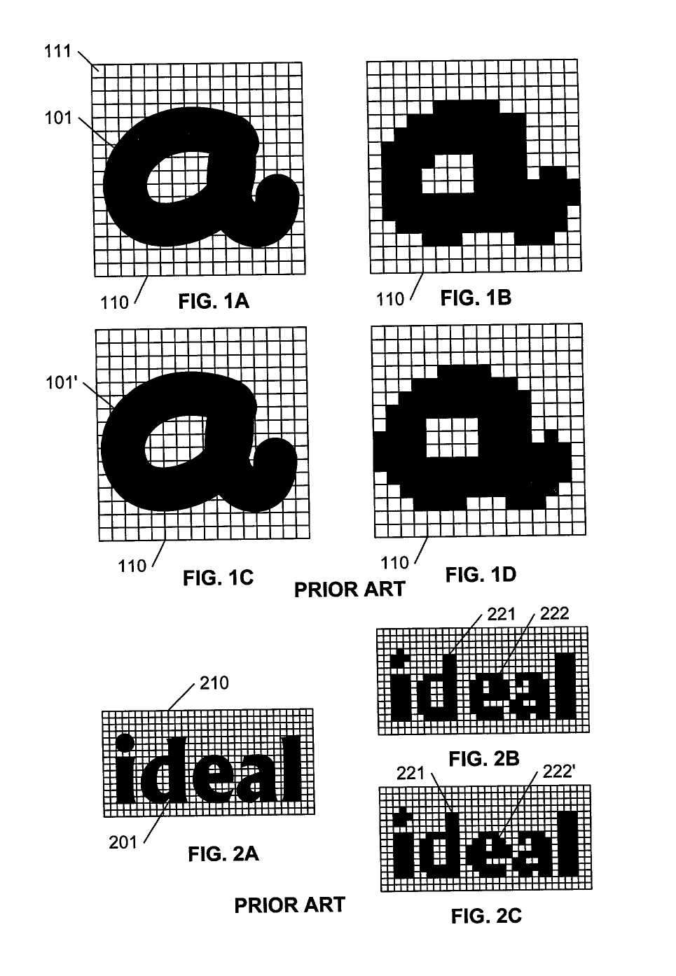

Throughout the drawings, the same reference numerals indicate similar or corresponding features or functions.

### DETAILED DESCRIPTION OF THE INVENTION

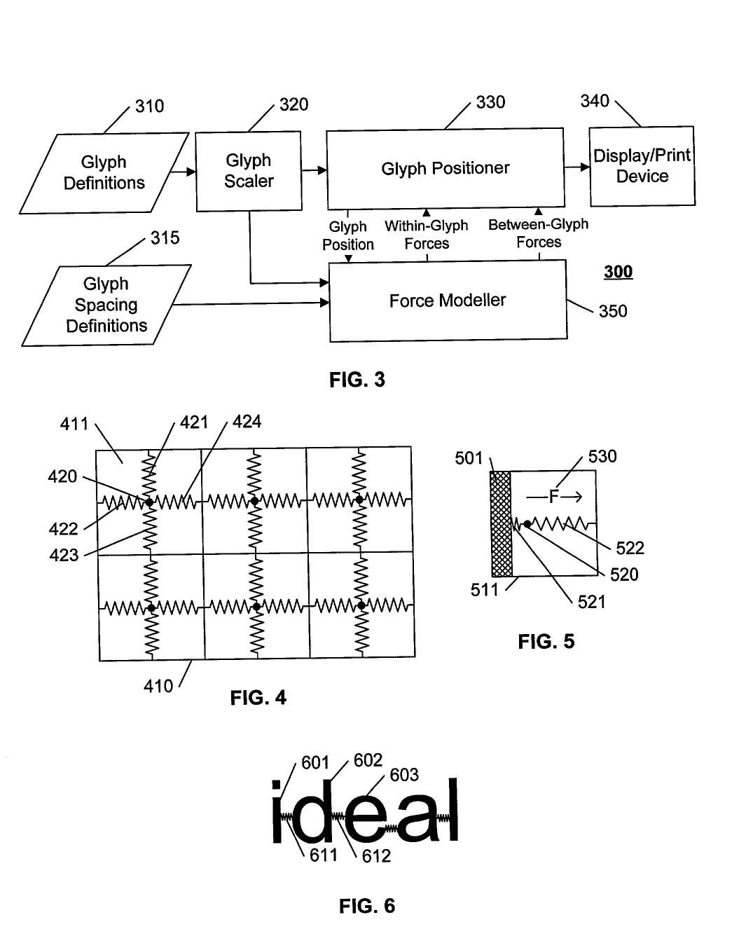

FIG. 3 illustrates an example block diagram of a rendering system 300 in accordance with this invention. The system 300 includes a conventional glyph scaler 320 that produces a scaled glyph, based on a glyph definition 310. This glyph definition 310 may be an analog description of the strokes that produce the glyph, a discrete description at a very high resolution, a conventional “True Font” font description of a character, a description corresponding to a device independent typesetting specification (DVI), and so on. The scale of the glyph to be rendered is based on the parameters of the particular application that initiates the rendering of the glyph.

In accordance with this invention, a glyph positioner 330 determines where to place each glyph on a display 340, based at least in part on the forces applied to the glyph as determined by a force modeler 350. The force modeler 350 is configured to model both within-glyph forces and between-glyph forces, based on a given glyph position relative to an array of pixels. In a preferred embodiment of this invention, the within-glyph forces are produced by the pixels that are partially covered by the glyph, and the between-glyph forces are produced based on a preferred spacing 315 between individual glyphs, as discussed further below.

In accordance with a first aspect of this invention, a glyph is acted upon by forces associated with each pixel. In a preferred embodiment, these forces are defined so as to ‘pull’ the glyph, to complete the coverage of partially covered pixels. Alternative force models, such as a pushing force, or a combination of pushing and pulling forces, will be apparent to one of ordinary skill in the art in view of this disclosure.

In the preferred model, it is assumed that the amount of visually displeasing distortion will be dependent upon the amount of coverage of the pixel by the glyph. If a pixel is only slightly covered, and is rendered white, only the slight coverage will be absent from the rendering. If the pixel is mostly covered, and is rendered black, only the slightly uncovered area of the pixel will be erroneously rendered black. In like manner, if a gray-scale is used to encode the tone of the pixel, a slightly covered pixel being rendered in a light gray shade may not be visually unpleasant, and a mostly covered pixel being rendered in a dark gray shade may not be noticeably different from the actual glyph, as well. On the other hand, a half covered pixel will be rendered half-wrong. If it is rendered white, the half of the area that is actually covered by the glyph will be rendered incorrectly, and if it is rendered black, the half of the area that is not covered by the glyph will be rendered incorrectly.

FIG. 4 illustrates an example model of a matrix 410 of pixels 411 in accordance with this invention. In this model, each pixel 411 is modeled as comprising a set of springs 421-424. Using this model, the center 420 of the four springs is moved toward the center of mass of the portion of the glyph that partially covers the pixel. The movement of the center 420 of the springs effects an equal and opposite force on the glyph. In a preferred embodiment, the magnitude of the force is dependent upon the amount of the glyph that is covering the pixel.

For ease of understanding, FIG. 5 illustrates a one-dimensional spring model of a pixel 511 that is partially covered by a region of a glyph 501. The spring model includes two springs 521, 522, and a center point 520. In this model, the pixel 511 exerts a force F 530 on the glyph in a horizontal direction. The partial covering of the pixel displaces the center point 520 of the springs 521, 522 to the left, toward the center-of-mass of the glyph region 501, causing spring 522 to exert the force F 530 to pull the glyph to the right. The magnitude of the force F 530 is dependent upon the area of the pixel that the glyph covers, as discussed further below.

An alternative interpretation of the force model is one in which the glyph corresponds to a continuous mass, and each pixel corresponds to a gravity well. If part of the glyph enters the gravity well, there will be a gravitational force exerted on the glyph to pull it entirely into the well. In such a model, an inverse square law is used to model the degree of force that is applied to the glyph, a maximum force being applied when the glyph is half way into the gravity well.

Any of a variety of other mechanical analogies may be used to derive an appropriate force generation model. Preferably, the selected force model and the first derivative of the force model should be continuous at the pixel boundaries, to avoid instabilities and anomalous behavior as the force model is applied to each pixel. If a discontinuous force model is used, numerical processing techniques that avoid such instabilities and anomalies, commonly known to one of ordinary skill in the art, are preferably also employed.

In the general case, the pixel model defines a force “density” that is applied to the glyph. In the example of a force that tends to pull the center of mass of the glyph to the center of the pixel, a unit-width pixel exerts a force on the glyph in a horizontal direction corresponding to:

$${F}_{x} = {\int }_{- 0.5}^{0.0} f ( x ) ⅆ x + {\int }_{0.0}^{+ 0.5} - f ( x ) ⅆ x , \qquad ( 1 )$$

where f(x) is the force density in the horizontal direction, x. In this equation, it is assumed that the force density f(x) that pulls the glyph toward the center from the left side (−0.5 to 0) is equal and opposite to the force density f(x) that pulls the glyph toward the center from the right side (0 to 0.5). This force density f(x) may vary with the distance from the center of the pixel, to provide a non-linear representation of the relative distortion caused by a partial coverage of a pixel. In a preferred embodiment, for simplicity, the force density is modeled as a step function, to form a linear force model, wherein:

f(x)=0, if the glyph does not cover the pixel at x, and

f(x)=k, if the glyph covers the pixel at x;

where k is a constant that facilitates normalization. Hereinafter, it is assumed that k=1, for ease of understanding. As can be seen, a totally covered pixel asserts zero force on the pixel, because the force density is equal but opposite on either side of the pixel. Conversely, a half covered pixel will provide a force of 0.5, toward the right (positive) if the pixel is covered on the left (−0.5 to 0), or toward the left (negative) if the pixel is covered on the right (0 to 0.5). A pixel that is 10% covered on the left exerts a force of 0.1 to the right, and a pixel that is 90% covered on the left also exerts a force of 0.1 to the right (0.5 -0.04). As noted above, alternative force models may be employed, such as one that pushes the glyph away when the pixel is only slightly covered, and pulls the glyph to increase the coverage when the pixel is mostly covered. The advantage to the preferred “increase coverage” model is the continuity of the model across the pixel surface, whereas a push-pull model will exhibit a substantial discontinuity at the center point, which could introduce instabilities in the below described force minimization algorithm. Techniques are common in the art to deal with such instabilities, but add to the complexity of the algorithm.

A similar set of equations may be used in the vertical direction. Most text-based applications of this invention maintain a fixed baseline, and fixed character heights, which can easily be accommodated in this force-based approach by constraining the pixels at the vertical extremes of the characters to remain fixed.

Having computed the force on the glyph caused by each pixel, the total force acting upon the glyph is merely the sum of the forces. In accordance with one aspect of this invention, the glyph is moved by this total force, in the direction of the force, until the total force is minimized. Except in the case of a constrained point on the glyph, such as along a baseline axis, the total force will be minimized to zero. By moving the glyph until the total force is minimized, a stable glyph with minimal distortion is produced (assuming that the force density model corresponds to a measure of the distortion produced by the rendering of a partially covered pixel as either totally covered or totally uncovered).

In a preferred embodiment, conventional iterative-search techniques are employed to reach the minimum-force position. That is, the glyph is moved slightly in the direction of the force, and the force is recomputed. If the force decreases, continue moving in the direction of the new force. If the force increases, or reverses direction, the minimum force point has been passed; therefore, shift the glyph even more slightly in the opposite direction and recompute the new force. Eventually, the magnitude of the shift of the glyph is determined to be below a given threshold, which is equivalent to a zero-magnitude shift, and the iterative process ceases.

Alternatively, another measure may be used to measure the degree of distortion, such as a sum of the square of the forces, corresponding to a measure of the energy in each spring model, or a sum of the square of ‘error’ terms that are independent of the individual forces. For example, the ‘error’ term may be the difference in area between the actual glyph coverage and the pixel area, as follows:

Error=1—glyph covered area, if the pixel is rendered black, and

Error=glyph covered area, if the pixel is rendered white.

In such an embodiment, the above detailed iterative-search technique will be applied, but using the defined measure of distortion, rather than the force, as the search parameter that is to be minimized.

In accordance with the second aspect of this invention, the above force-mediated determination of a proper placement of a glyph is also applied to determine the proper placement of glyphs within a multi-glyph arrangement.

FIG. 6 illustrates an example force model for a multi-glyph rendering, wherein each glyph 601, 602, etc. is connected by a spring 611, 612, etc. to its adjacent glyph. Each spring is ‘sized’ to correspond to an ideal placement between sets of glyphs, and is arranged such that contractions or expansions from this ideal size exert a force on each of the connected glyphs. For example, as presented in the aforementioned U.S. Pat. No. 5,910,805, typesetting standards exist for determining the proper spacing between characters for each font type and/or style. These typesetting standards, or other sets of spacing standards, are used in a preferred embodiment of this invention to define the spring-constant associated with pairs of glyphs in a multi-glyph word. As each glyph is moved based on the above pixel-based forces, this movement will add or decrease the tension of the springs that are attached to the glyph. In a preferred embodiment of this invention, the positioning of each glyph in a multi-glyph word is effected by including the inter-glyph spring force in the total force that determined for each glyph.

In a preferred embodiment of this invention, the spring-constant associated with the between-glyph springs, relative to the force density associated with each pixel, is determined based on the relative significance of improperly spaced characters compared to distorted characters. If proper spacing is deemed important, a relatively large spring-constant is employed, if character sharpness is deemed important, a relatively small spring-constant is employed. The spring-constant in a preferred embodiment of this invention is also dependent upon the size of the glyphs, because the visual effects of a mis-spacing are more apparent with larger characters.

Alternative models to a spring model between glyphs will be evident to one of ordinary skill in the art in view of this disclosure. For example, in an alternative preferred embodiment of this invention, a non-linear force is modeled between glyphs, because an erroneous spacing is often not visually disturbing until it reaches a threshold limit, either too close or too far, and increases beyond these thresholds are very apparent.

The foregoing merely illustrates the principles of the invention. It will thus be appreciated that those skilled in the art will be able to devise various arrangements which, although not explicitly described or shown herein, embody the principles of the invention and are thus within its spirit and scope. For example, the above examples treated each glyph as a rigid body. An alternative embodiment includes the modeling of the glyph as a somewhat flexible, or elastic, body. For example, the “legs” of the letters “m” and “n” may be modeled as being connected by an elastic connecting member, such that the legs are independently operated upon by the forces exerted by their corresponding pixels, and the elastic connecting member provides a force that tends to hold them at their proper spacing, similar to the springs of the multi-glyph models, discussed above. In like manner, although the invention is presented in the context of glyphs placed on a vertical line that are translated in an orthogonal direction, other configurations are common in the art, such as text that spirals up and around a column, text that appears on a surface of an object that is not parallel to the surface of the display device, and so on. In these alternative configurations, the principles of this invention apply, with the movement of the glyph for proper spacing corresponding to the movement or placement of the glyph in the alternative reference coordinate system for the text. These and other system configuration and optimization features will be evident to one of ordinary skill in the art in view of this disclosure, and are included within the scope of the following claims.

I claim:

1. A rendering system comprising:
a force modeler that is configured to model forces that are applied to a glyph in dependence upon a placement of the glyph, and
a glyph positioner, operably coupled to the force modeler, that is configured to select a preferred placement of the glyph, based on the forces that are applied to the glyph at the preferred placement.

2. The rendering system of claim 1, further including
a glyph scaler that is configured to provide the glyph to the glyph positioner, based on a glyph description.

3. The rendering system of claim 1, further including
at least one of a display device and a print device that is configured to render the glyph at the preferred placement.

4. The rendering system of claim 1, wherein
the force modeler is configured to determine the forces that are applied to the glyph based upon an amount of coverage of a set of pixels of an array of pixels.

5. The rendering system of claim 4, wherein
the set of pixels comprises pixels that are partially covered by the glyph.

6. The rendering system of claim 4, wherein
the force modeler is further configured to determine the forces that are applied to the glyph based on a preferred spacing of the glyph relative to an adjacent glyph.

7. The rendering system of claim 1, wherein
the force modeler is configured to determine the forces that are applied to the glyph based on a preferred spacing of the glyph relative to an adjacent glyph.

8. The rendering system of claim 1, wherein
the force modeler is configured to determine the forces that are applied to the glyph based on at least one of:
a linear model,
a force-density model,
a spring model, and
a gravity well model.

9. The rendering system of claim 1, wherein
the force modeler is configured to determine the forces that are applied to the glyph, based on a coverage of one or more pixels by the glyph, so as to effect a change of the coverage of the one or more pixels by the glyph.

10. A method of rendering a glyph to an array of pixels, the method comprising:
modeling forces that are applied to the glyph in dependence upon a placement of the glyph, and
selecting a preferred placement of the glyph, based on the forces that are applied to the glyph at the preferred placement.

11. The method of claim 10, further including
scaling the glyph, based on a description of the glyph.

12. The method of claim 10, further including
rendering the glyph at the preferred placement on at least one of: a display device and a printer device.

13. The method of claim 10, wherein
determining the forces that are applied to the glyph is based upon an amount of coverage of a set of pixels of the array of pixels.

14. The method of claim 13, wherein
the set of pixels comprises pixels that are partially covered by the glyph.

15. The method of claim 13, wherein
determining the forces that are applied to the glyph is further based on a preferred spacing of the glyph relative to an adjacent glyph.

16. The method of claim 10, wherein
determining the forces that are applied to the glyph is based on a preferred spacing of the glyph relative to an adjacent glyph.

17. The method of claim 10, wherein
determining the forces that are applied to the glyph is based on at least one of:
a linear model,
a force-density model,
a spring model, and
a gravity well model.

18. The method of claim 10, wherein
determining the forces that are applied to the glyph is based on a coverage of one or more pixels by the glyph, so as to effect a change of the coverage of the one or more pixels by the glyph.
